(19) United States
(12) Patent Application Publication
(10) Pub. No.: US 2024/0155491 A1
(43) Pub. Date: May 9, 2024

(54) Method And Apparatus For Low Power Wake-Up Signal Monitoring In Mobile Communications

(71) Applicant: MediaTek Inc., Hsinchu City (TW)

(72) Inventors: Chien-Chun Cheng, Hsinchu City (TW); Wei-De Wu, Hsinchu City (TW); Yi-Ju Liao, Hsinchu City (TW); Yi-Chia Lo, Hsinchu City (TW); Cheng-Hsun Li, Hsinchu City (TW)

(21) Appl. No.: 18/379,634

(22) Filed: Oct. 12, 2023

Related U.S. Application Data
(60) Provisional application No. 63/382,553, filed on Nov. 7, 2022.

(51) Int. Cl. H04W 52/02; H04L 5/00

(52) U.S. Cl. CPC H04W 52/0229; H04L 5/0048; H04W 52/0235

(57) ABSTRACT

Various solutions for low-power wake-up signal (LP-WUS) monitoring with respect to user equipment and network node in mobile communications are described. An apparatus may receive a configuration from a network node. The apparatus may comprise a main radio (MR) and a lower-power wake-up radio (LP-WUR). The apparatus may determine whether to activate or deactivate a low-power wake-up signal (LP-WUS) monitoring by the LP-WUR according to at least one pre-configured condition in the configuration. The apparatus may receive an LP-WUS from the network node via the LP-WUR in an event that the LP-WUS monitoring is activated.

### CROSS REFERENCE TO RELATED PATENT APPLICATION(S)

The present disclosure is part of a non-provisional application claiming the priority benefit of U.S. Patent Application No. 63/382,553, filed 7 Nov. 2022, the content of which herein being incorporated by reference in its entirety.

### TECHNICAL FIELD

The present disclosure is generally related to mobile communications and, more particularly, to low power wake-up signal (LP-WUS) monitoring with respect to user equipment (UE) and network apparatus in mobile communications.

### BACKGROUND

Unless otherwise indicated herein, approaches described in this section are not prior art to the claims listed below and are not admitted as prior art by inclusion in this section.

The 5^{th}-generation (5G) network, despite its enhanced energy efficiency in bits per Joule (e.g., 417% more efficiency than a 4G network) due to its larger bandwidth and better spatial multiplexing capabilities, may consume over 140% more energy than a 4G network.

Therefore, it is important to improve 5G network power savings. There are many conflicts among performance metrics. Quality of service (QoS) and power savings may need a tradeoff. Some local optimal solutions may not achieve the global/overall optimum. For example, the wake-up signal (WUS) saving user equipment (UE) power by 20% may degrade 30% of base station (BS) power savings.

The 5G device may have to be recharged per week or day based on its usage time. In general, 5G device may consume tens of milliwatts in the radio resource control (RRC) idle state or in the RRC inactive state, and consume hundreds of milliwatts in the RRC connected state. Therefore, how to prolong battery of the 5G device life is necessary for improving energy efficiency and achieving a better user experience.

Currently, the UEs may need to periodically wake up once per discontinuous reception (DRX) cycle which is used to dominate the power consumption in periods with no signaling or data traffic. If the UEs can wake up only when they are triggered, e.g., a paging, the power consumption may be significantly reduced. This can be achieved by using a WUS to trigger the main radio (MR) and a separate receiver, i.e., a low power wake-up radio (LP-WUR) which has the ability to monitor the low-power WUS (LP-WUS) with low power consumption. The MR's operations for data transmission and reception can be turned off or set to the deep sleep unless the MR is turned on.

Accordingly, how to activate or deactivate the LP-WUS monitoring for power saving becomes an important issue for the newly developed wireless communication network. Therefore, there is a need to provide proper schemes and designs for the LP-WUS monitoring.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is propose schemes, concepts, designs, systems, methods and apparatus pertaining to activate or deactivate LP-WUS monitoring in mobile communications. It is believed that the above-described issue would be avoided or otherwise alleviated by implementing one or more of the proposed schemes described herein.

In one aspect, a method may involve an apparatus receiving a configuration from a network node, wherein the apparatus may comprise a main radio (MR) and a lower-power wake-up radio (LP-WUR). The method may also involve the apparatus determining whether to activate or deactivate a low-power wake-up signal (LP-WUS) monitoring by the LP-WUR according to at least one pre-configured condition in the configuration. The method may further involve the apparatus receiving an LP-WUS from the network node via the LP-WUR in an event that the LP-WUS monitoring is activated.

In another aspect, an apparatus may involve a transceiver which, during operation, wirelessly communicates with at least one network node and comprises an MR and an LP-WUR. The apparatus may also involve a processor communicatively coupled to the transceiver. The processor may receive, via the transceiver, a configuration from the network node. The processor may also determine whether to activate or deactivate an LP-WUS monitoring by the LP-WUR according to at least one pre-configured condition in the configuration. The processor may further receive, via the transceiver, an LP-WUS from the network node via the LP-WUR in an event that the LP-WUS monitoring is activated.

In another aspect, a method may involve a network node determining a configuration, wherein the configuration comprises at least one pre-configured condition for activating or deactivating an LP-WUS monitoring. The method may also involve the network node transmitting the configuration to a user equipment (UE). The method may further involve the network node transmitting an LP-WUS to the UE in an event that the LP-WUS monitoring is activated.

It is noteworthy that, although description provided herein may be in the context of certain radio access technologies, networks and network topologies such as 5th Generation System (5GS) and 4G EPS mobile networking, the proposed concepts, schemes and any variation(s)/derivative(s) thereof may be implemented in, for and by other types of wireless and wired communication technologies, networks and network topologies such as, for example and without limitation, Ethernet, Universal Terrestrial Radio Access Network (UTRAN), E-UTRAN, Global System for Mobile communications (GSM), General Packet Radio Service (GPRS)/Enhanced Data rates for Global Evolution (EDGE) Radio Access Network (GERAN), Long-Term Evolution (LTE), LTE-Advanced, LTE-Advanced Pro, IoT, Industrial IoT (IIoT), Narrow Band Internet of Things (NB-IoT), and any future-developed networking technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a serving cell measurement relaxation under schemes in accordance with implementations of the present disclosure.

FIG. 2 is a diagram depicting an example scenario of a search space set group (SSSG) switching under schemes in accordance with implementations of the present disclosure.

FIG. 3 is a block diagram of an example communication system in accordance with an implementation of the present disclosure.

FIG. 4 is a flowchart of an example process in accordance with an implementation of the present disclosure.

FIG. 5 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to activate or deactivate the low-power wake-up signal (LP-WUS) in mobile communications. According to the present disclosure, a number of possible solutions may be implemented separately or jointly. That is, although these possible solutions may be described below separately, two or more of these possible solutions may be implemented in one combination or another.

In conventional technology, the additional synchronization signal block (SSB) search may generate 11% power consumption in the discontinuous reception (DRX) case. The SSB search may happen after the main radio (MR) wakes up from the ultra-deep sleep state in which the MR may turn off the low-speed clock and stop maintaining the system frame number (SFN) timing. Therefore, under the conventional schemes/architectures, the MR may need additional time to get SFN to know how to schedule its timeline for the SSB measurement and paging occasion (PO) monitoring.

Accordingly, the present disclosure proposes some solutions to resolve the issues.

In some implementations, the UE may comprise an MR and a low-power wake-up radio (LP-WUR or LR). The MR and LP-WUR may exchange messages within the UE and receive independent messages from network node. The LP-WUR may mainly monitor the LP-WUS and may monitor some new radio (NR) reference signals for synchronization and cell quality monitoring.

In some implementations, the LP-WUR may receive the SFN to help MR to find the first SSB. In an example, the LP-WUR may receive the SFN or receive a simplified version of SFN via one of the multiple LP-WUS sequences. In another example, the LP-WUR may receive the SFN or receive the simplified version of SFN via a data payload following the synchronization LP-WUS sequences. The simplified version of SFN may provide part of SFN information with a larger granularity.

The MR may determine whether to skip the SSB search based on whether the LP-WUR receives SFN. In an example, if the LP-WUR receives the SFN successfully, the LP-WUR may indicate the MR to skip the additional SSB search and the LP-WUR may use the received SFN for the SSB measurement. In another example, if the received SFN is still valid when the LP-WUR indicates a WUS to the MR, e.g., based on a validity timer, the LP-WUR may indicate the MR to skip the additional SSB search and LP-WUR may use the received SFN for the SSB measurement.

In some implementations, the MR may receive a time window for additional SSB search from the network node. In an example, the MR or the LP-WUR may receive an offset between the timing of the LP-WUS reception and the timing of the first SSB which the MR should measure. The offset may be provided by the network node in milliseconds (ms) or slots through the system information (SI), radio resource control (RRC), medium access control control-element (MAC-CE), or downlink control information (DCI) formats signaling.

The MR may determine whether to the stop additional SSB search after 20 ms based on the received offset, the time window, or the SSB periodicity configurations from the network node through the RRC or SI messages.

The MR may stop the additional SSB searches after waking up if the search time is beyond a threshold based on the ramp-up time, the given offset, the time window, the SSB configurations, or the SSB default configurations, e.g., 20 ms of periodicity.

The MR may report one value to network node based on a list of transition time values supported by the MR. The list may be provided by the network node through RRC or may be pre-determined for the MR. The transition time values may have a unit of seconds or milliseconds. The transition time values may comprise one or more of the following time parameters, e.g., the ramping up/down time, the initial SSB search time, the frequency synchronization time, the SSB process time, and the required radio resource management (RRM) time.

In some implementations, the LP-WUR may maintain the SFN obtained from the MR. In an example, the MR may receive an indication from the network node to request the LP-WUR to maintain the SFN when the MR is in the ultra-deep sleep. The indication may be received through the RRC, MAC-CE, or DCI format.

The MR may receive the timing relationship between the SFN and the LP-WUS, e.g., the timing offset between the SSB and the LP-WUS, and/or the periodicity of LP-WUS.

The LP-WUR may receive the SFN from the MR before the MR enters ultra-deep sleep, and the LP may maintain the SFN timing by monitoring and receiving a synchronization preamble or a data payload from the LP-WUS receptions.

The LP-WUR may indicate the maintained SFN to the MR, and the MR may determine whether to terminate/skip the additional SSB search.

In some implementations, the MR may detect whether there is a false alarm according to the SFN maintained by the LP-WUR.

The LP-WUR may indicate a wake-up indication to the MR if the LP-WUS reception indicates a wake-up request. The wake-up indication may comprise the maintained SFN information.

The MR may determine whether to stop the wake-up procedure by comparing the SFN maintained by the LP-WUR with the SFN received in SI by the MR.

The MR may identify a false alarm if the difference between these two SFN values is beyond a configurable threshold configured by the network node.

The MR may enter the sleep modes or the active/waked-up modes after the false alarm has been identified.

In some implementations, the MR may detect whether the public land mobile network (PLMN) selection, the frequency band, or the cell identity (ID) is still valid according to the cell ID information, the frequency band information, or the PLMN information maintained by the LR.

The LP-WUR may receive and maintain the cell ID information, the frequency band information, and the PLMN information from the MR. The LP-WUR may receive full information, partial information or a change notification for the cell ID information, the frequency band information, or the PLMN information. The LP-WUR may receive and maintain the cell ID information, the frequency band information, and the PLMN information according to the LP-WUS from the network node.

The MR may trigger an initial cell search or a PLMN selection if the MR cannot find any SSB after a period or a few trials. The period of the trial may be configured by the network node in units of seconds, slots, or milliseconds through the RRC or SI.

The MR may trigger an initial cell search or a PLMN selection if any one of the information received by the MR after waking up is not aligned with the maintained cell ID information or PLMN information.

The UE may perform the serving cell measurement in every DRX for maintaining the link. On the other hand, if the MR is waked-up for the serving cell measurement every DRX cycle, the power-saving benefit with the LP-WUR will be reduced.

Therefore, it should be investigated how to reduce the MR's serving cell measurements when the UE comprise the LP-WUR. For example, after MR detects a good serving cell quality, the MR can relax the serving cell measurement when the UE comprises the LP-WUR. The LP-WUR may monitor whether the serving cell quality becomes worse such that the LP-WUR needs to wakes up the MR to perform the normal serving cell measurements (i.e., no relaxation).

Accordingly, the present disclosure proposes some solutions to resolve the issues.

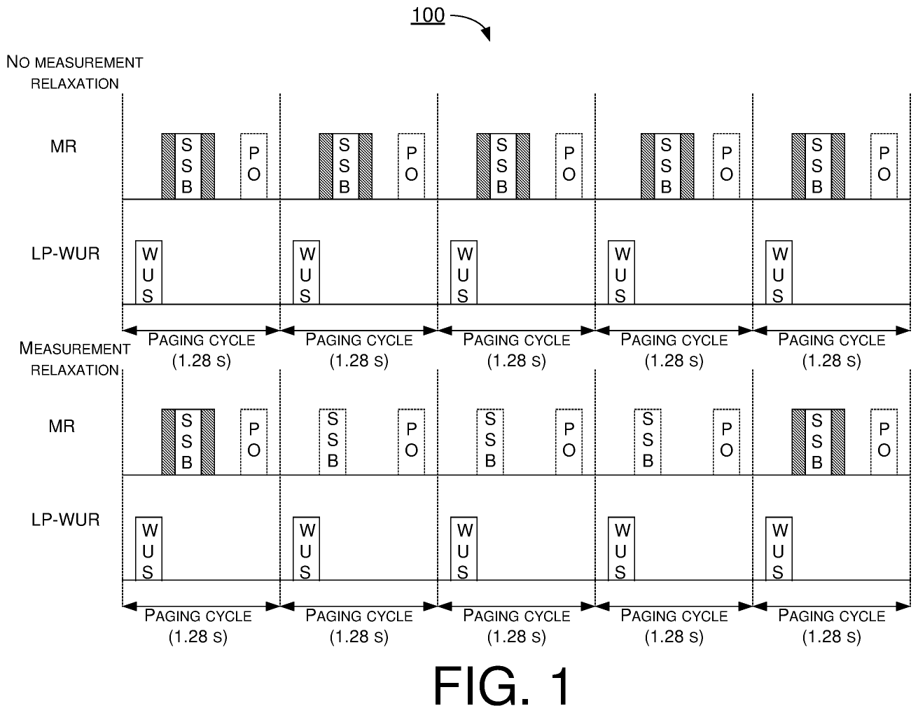

FIG. 1 illustrates an example scenario 100 for a serving cell measurement relaxation under schemes in accordance with implementations of the present disclosure. Scenario 100 involves a network node (e.g., a macro base station and a micro base station) and a UE, which may be a part of a wireless communication network (e.g., an LTE network, a 5G/NR network, an IoT network or a 6G network). Referring to FIG. 1, it is assumed that the LP-WUS is applied for the paging monitoring. The PO monitoring is only required when LP-WUS is received, i.e., the PO monitoring occurs with low probability. When there is no measurement relaxation and the UE does not comprise the LP-WUR, the MR may measure 1 SSB and monitor 1 paging early indication (PEI). As shown in upper part of FIG. 1, when there is no measurement relaxation on the serving cell, the MR may measure 1 SSB and the LP-WUR may monitor 1 LP-WUS per DRX cycle. As shown in lower part of FIG. 1, when there are K-times (e.g., 4-times as shown in FIG. 1) measurement relaxations on the serving cell, the MR may measure 1 SSB every K DRX cycles, and the LP-WUR may monitors 1 LP-WUS per DRX cycle, wherein K is an integer. Referring to FIG. 1, 36% power-saving (PS) gain may be achieved when 4-times measurement relaxation is allowed in the serving cell. The most PS gain may come from skipping SSB measurement by the MS.

In some implementations, the UE may receive a configuration from the network node, and the UE may comprise the MR and the LP-WUR. The UE may determine whether to activate or deactivate an LP-WUS monitoring by the LP-WUR according to at least one pre-configured condition in the configuration from the network node. In addition, the UE may receive an LP-WUS from the network node via the LP-WUR when the LP-WUS monitoring is activated.

In some implementations, the UE may further offload an RRM measurement from the MR to the LP-WUR when the LP-WUS monitoring is activated. In some implementations, the pre-configured condition in the configuration may comprise that the LP-WUS is a periodic reference signal used for a low-power radio (LR) measurement.

In some implementations, the UE may deactivate the LP-WUS monitoring on the LP-WUR when the RRM measurement in the MR is relaxed. Then, the UE may perform a measurement with a relaxed periodicity via the MR.

In some implementations, the UE may deactivate the LP-WUS monitoring on the LP-WUR when a result of LP-WUS based measurement on the LP-WUR is below a threshold. Then, the UE may perform a measurement via the MR.

In some implementations, the UE may determine whether to activate or deactivate the LP-WUS monitoring by the LP-WUR according to a channel condition. In some implementations, the channel condition may comprise that a coverage of the LP-WUS is sufficient or is insufficient.

In some implementations, the MR may offload the serving cell measurement to the LP-WUR if the LP-WUS provides sufficient information and the LP-WUR has the capability of performing the serving cell measurement.

The MR may receive the serving cell measurement relaxation configurations from the network node through the SI, RRC, MAC-CE, or DCI format. In an example, the serving cell measurement relaxation configurations may indicate how to skip the measurements, e.g., skip three measurements after one SSB measurement. In another example, the serving cell measurement relaxation configurations may comprise the conditions of the UE being able to skip the serving cell measurement. The conditions may comprise at least one of the LP-WUR being ON, the high SNR, and the low UE mobility.

In some implementations, the MR may trigger the serving cell measurement relaxation when the LP-WUR starts monitoring. In another example, the MR may trigger the serving cell measurement relaxation after the LP-WUR receives an indication from the network node. In some implementations, the MR may trigger the serving cell measurement relaxation when the LP-WUR sends an indication to the MR to allow the serving cell measurement relaxation on the MR.

In some implementations, the MR may skip the serving cell measurement based on the serving cell measurement relaxation configurations if the required conditions are met. After the MR skips the serving cell measurement, the LP-WUR may start monitoring the serving cell measurement.

In some implementations, the LP-WUR may stop the serving cell measurement relaxation for the MR if the LP-WUR identifies some errors and/or the LP-WUR cannot monitor the serving cell measurement. After the LP-WUR stop the serving cell measurement relaxation for the MR, the LP-WUR should wake up the MR even if the LP-WUR does not receive the LP-WUS from the network node.

In some implementations, the LP-WUR may receive the LP-WUS to maintain the serving cell measurement. The LP-WUS may comprise partial or simplified information carried by NR SSB, MIB, SIB1, or comprise the paging messages to perform the serving cell measurement.

In some implementations, the LP-WUR may combine one or multiple LP-WUSs to measure the serving cell quality. The number of LP-WUSs may be configured by network node through the RRC, MAC-CE, and DCI format received by the MR.

In some implementations, the LP-WUR may determine the serving cell quality based on a configurable threshold configured by the network node through the RRC, MAC-CE, and DCI format received by the MR.

In some implementations, the MR may stop skipping or relaxing the serving cell measurement if the LP-WUR receives an LP-WUS for paging or the LP-WUR identifies the serving cell quality is below a configurable threshold provided by the network node.

In some implementations, the MR may stop skipping or relaxing the serving cell measurement if the required conditions are not satisfied.

In some implementations, the MR may stop skipping or relaxing the serving cell measurement if the LP-WUR receives an indication from the network node.

In some implementations, the MR may stop skipping or relaxing the serving cell measurement if the LP-WUR sends an indication to the MR that is not allowed the serving cell measurement relaxation on the MR.

In some implementations, the MR may stop skipping or relaxing the serving cell measurement after the LP-WUR wakes up the MR for possible reasons, e.g., out-of-sync (i.e., cannot receive always-on LP-WUS), low cell quality, receive the LP-WUS, or other indications in the data payload.

In some implementations, the MR may report its capability to support the serving cell measurement relaxation and the capability of monitoring and detecting the LP-WUS.

In the RRC connected mode, the UE can monitor the downlink control signal of power saving (DCP) to know whether to start the on-duration timer of the upcoming DRX cycle. On the other hand, the DCP cannot be used to adjust physical downlink control channel (PDCCH) monitoring behavior during the on-duration time, or there is no DRX configured. In the applications of Extended Reality (XR) with large timing jitter, a large on-duration timer may be used or the DRX may not be configured. Therefore, the DCP cannot be used to reduce the UE power consumption for the applications.

Accordingly, the present disclosure proposes some solutions to resolve the issues.

In some implementations, the power saving (PS) adaptation (e.g., search space set group (SSSG) switching) may be reused. The network node may configure one UE-specific SSSG for the LP-WUR to monitor LP-WUS and configure another SSSG for the MR to monitor DCI.

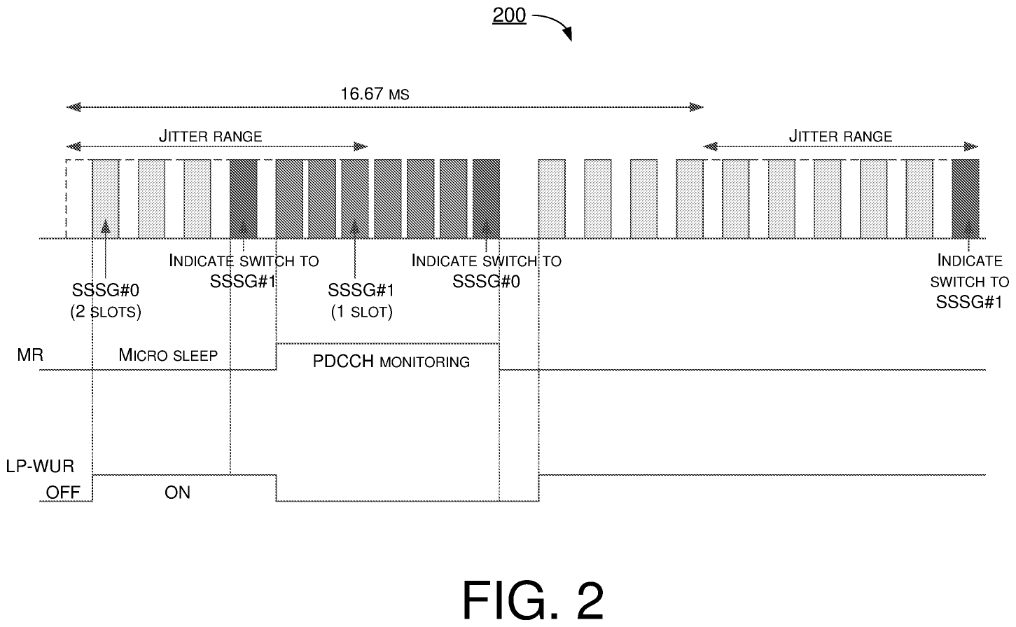

FIG. 2 illustrates an example scenario 200 for a search space set group (SSSG) switching under schemes in accordance with implementations of the present disclosure. Scenario 200 involves a network node (e.g., a macro base station and a micro base station) and a UE, which may be a part of a wireless communication network (e.g., an LTE network, a 5G/NR network, an IoT network or a 6G network). Referring to FIG. 2, the UE may monitor LP-WUS in SSSG #0 via the LP-WUR and monitor PDCCH in SSSG #1 via the MR. In SSSG #0, the MR may enter a micro sleep, and the LP-WUR may be turned on (i.e., stay ON). In SSSG #1, the MR may perform PDCCH monitoring (and physical downlink shared channel (PDSCH) processing), and the LP-WUR may be turned off (i.e., stay OFF). The UE may switch from SSSG #0 to SSSG #1 if the LP-WUR detects a wake-up indication. If there is no new data after the SSSG timer (e.g., 4 ms) in SSSG #1, the UE may switch to SSSG #0. The PS gain may highly depend on the time of the UE staying in SSSG #0 in which the MR may enter micro sleep.

When the LP-WUS is configured to be associated with one SSSG, e.g., SSSG #0, the UE may not perform PDCCH monitoring of the SSSG. In addition, the UE may monitor the LP-WUS to determine whether to perform SSSG switch via the LP-WUR. The UE may determine the LP-WUS monitoring occasion(s) by reusing the configurations for PDCCH monitoring occasion of the SSSG (e.g., monitoringSlotPeriodicityAndOffset, duration and monitoringSymbolsWithinSlot).

In some implementations, the LP-WUR may monitor during SSSG #0, and the MR may monitors during SSSG #1.

The LP-WUR may monitor the LP-WUS in a configured SSSG (e.g., SSSG #0) which is configured by the network node in a unit of ms or slot based on the sub-carrier space (SCS) configurations of the MR. The LP-WUS may indicate a pre-configured SSSG switch. The MR may switch the SSSG if the LP-WUR indicates an SSSG switch received from the network node.

When the LP-WUR detects an LP-WUS and a value of the SSSG switching flag field in the LP-WUS is 0, for the serving cell, the MR may start monitoring PDCCH according to the search space sets with group index 0 and stop monitoring PDCCH according to the search space sets with group index 1.

When the LP-WUR detects an LP-WUS and a value of the SSSG switching flag field in the LP-WUS is 1, for the serving cell, the MR may start monitoring PDCCH according to the search space sets with group index 1, and stop monitoring PDCCH according to the search space sets with group index 0.

When the LP-WUR monitors LP-WUS for a serving cell according to search space sets with group index 1, for the serving cell, the MR may start monitoring PDCCH for the serving cell according to search space sets with group index 0, and stop monitoring PDCCH according to search space sets with group index 1.

When the LP-WUR detects an LP-WUS by monitoring PDCCH according to a search space set with group index 0, for the serving cell, the MR may start monitoring PDCCH according to the search space sets with group index 1, and stop monitoring PDCCH according to the search space sets with group index 0.

The MR may determine a slot and a symbol in the slot to start or stop the PDCCH monitoring according to search space sets for a serving cell. In an example, the network node may provide the searchSpaceGroupldList to the UE, and the UE may obtain the search space sets for a serving cell according to the searchSpaceGroupldList. In another example, if the network node provides the cellGroupsForSwitchList to the UE, the UE may obtain the search space sets for a set of serving cells according to the cellGroupsForSwitchList. According to the configuration in the searchSpaceGroupldList or the cellGroupsForSwitchList, the MR may determine a slot and a symbol in the slot to start or stop the PDCCH monitoring based on the smallest SCS configuration μ among all configured DL (bandwidth parts) BWPs in the serving cell or in the set of serving cells. In the serving cell where the UE receives a PDCCH, the UE may detect a corresponding LP-WUS which is used to trigger the start or stop of PDCCH monitoring according to search space sets.

When the LP-WUS received by the LP-WUR indicates that the MR needs to start the PDCCH monitoring according to the search space sets with a first group index and stop the PDCCH monitoring according to the search space sets with a second group index, the MR may perform the operations based on the indication.

When the LP-WUS received by the LP-WUR indicates that the PDCCH monitoring for a duration on the active DL BWP of a serving cell needs to be skipped, the MR may start skipping the PDCCH monitoring at the beginning of the first slot, after the last symbol of the PDCCH reception providing the DCI format with the PDCCH monitoring adaptation field.

In some implementations, the MR may transmit a PUCCH providing a positive scheduling request (SR) after the MR detects a DCI format providing the PDCCH monitoring adaptation field. The DCI format providing the PDCCH monitoring adaptation field may indicate to the MR that the PDCCH monitoring for the duration of the active DL BWP of the serving cell needs to be skipped. In the implementations, the MR may resume the PDCCH monitoring starting at the beginning of the first slot after the last symbol of the PUCCH transmission.

### Illustrative Implementations

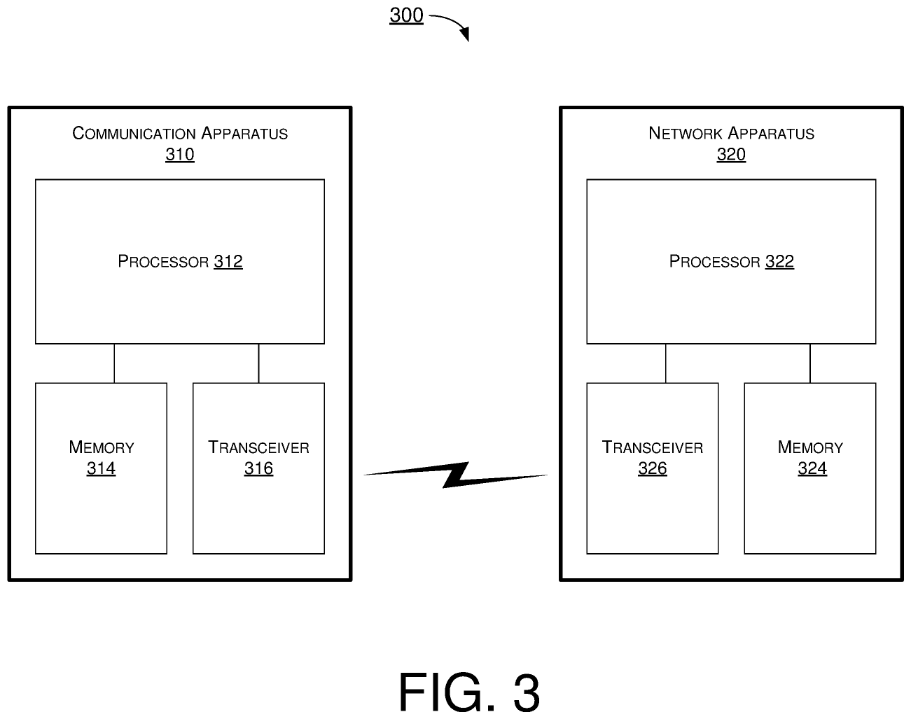

FIG. 3 illustrates an example communication system 300 having at least an example communication apparatus 310 and an example network apparatus 320 in accordance with an implementation of the present disclosure. Each of communication apparatus 310 and network apparatus 320 may perform various functions to implement schemes, techniques, processes and methods described herein pertaining to activate or deactivate the LP-WUS monitoring in mobile communications, including the various schemes described above with respect to various proposed designs, concepts, schemes and methods described above and with respect to user equipment and network apparatus in mobile communications, including scenarios/schemes described above as well as process 400 and process 500 described below

Communication apparatus 310 may be a part of an electronic apparatus, which may be a UE such as a portable or mobile apparatus, a wearable apparatus, a wireless communication apparatus or a computing apparatus. For instance, communication apparatus 310 may be implemented in a smartphone, a smartwatch, a personal digital assistant, a digital camera, or a computing equipment such as a tablet computer, a laptop computer or a notebook computer. Communication apparatus 310 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 310 may be implemented in a smart thermostat, a smart fridge, a smart door lock, a wireless speaker or a home control center. Alternatively, communication apparatus 310 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 310 may include at least some of those components shown in FIG. 3 such as a processor 312, for example. Communication apparatus 310 may further include one or more other components not pertinent to the proposed scheme of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a part of a network apparatus, which may be a network node such as a satellite, a base station, a small cell, a router or a gateway. For instance, network apparatus 320 may be implemented in an eNodeB in an LTE network, in a gNB in a 5G/NR, IoT, NB-IoT or IIoT network or in a satellite or base station in a 6G network. Alternatively, network apparatus 320 may be implemented in the form of one or more IC chips such as, for example and without limitation, one or more single-core processors, one or more multi-core processors, or one or more RISC or CISC processors. Network apparatus 320 may include at least some of those components shown in FIG. 3 such as a processor 322, for example. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including autonomous reliability enhancements in a device (e.g., as represented by communication apparatus 310) and a network (e.g., as represented by network apparatus 320) in accordance with various implementations of the present disclosure.

In some implementations, communication apparatus 310 may also include a transceiver 316 coupled to processor 312 and capable of wirelessly transmitting and receiving data. The transceiver 316 may comprise a main radio and an LP-WUR. In some implementations, communication apparatus 310 may further include a memory 314 coupled to processor 312 and capable of being accessed by processor 312 and storing data therein. In some implementations, network apparatus 320 may also include a transceiver 326 coupled to processor 322 and capable of wirelessly transmitting and receiving data. In some implementations, network apparatus 320 may further include a memory 324 coupled to processor 322 and capable of being accessed by processor 322 and storing data therein. Accordingly, communication apparatus 310 and network apparatus 320 may wirelessly communicate with each other via transceiver 316 and transceiver 326, respectively. To aid better understanding, the following description of the operations, functionalities and capabilities of each of communication apparatus 310 and network apparatus 320 is provided in the context of a mobile communication environment in which communication apparatus 310 is implemented in or as a communication apparatus or a UE and network apparatus 320 is implemented in or as a network node of a communication network.

In some implementations, processor 312 may receive, via transceiver 316, a configuration from network apparatus 320, wherein transceiver 316 of communication apparatus 310 may comprise an MR and an LP-WUR. Processor 312 may determine whether to activate or deactivate an LP-WUS monitoring by the LP-WUR according to at least one pre-configured condition in the configuration. Processor 312 may receive an LP-WUS from network apparatus 320 via the LP-WUR in an event that the LP-WUS monitoring is activated.

In some implementations, processor 312 may offload an RRM measurement from the MR to the LP-WUR in an event that the LP-WUS monitoring is activated.

In some implementations, the at least one pre-configured condition may comprise that the LP-WUS is a periodic reference signal used for an LR measurement.

In some implementations, processor 312 may deactivate the LP-WUS monitoring on the LP-WUR in an event that the RRM measurement in the MR is relaxed. Processor 312 may performing a measurement with a relaxed periodicity via the MR.

In some implementations, processor 312 may deactivate the LP-WUS monitoring on the LP-WUR in an event that a result of LP-WUS based measurement on the LP-WUR is below a threshold. Processor 312 may perform a measurement via the MR.

In some implementations, processor 312 may determine whether to activate or deactivate the LP-WUS monitoring by the LP-WUR according to a channel condition.

In some implementations, the channel condition may comprise that a coverage of the LP-WUS is sufficient or is insufficient.

In some implementations, processor 322 may determine a configuration, wherein the configuration may comprise at least one pre-configured condition for activating or deactivating an LP-WUS monitoring. Processor 322 may transmit, via transceiver 326, the configuration to communication apparatus 310. Processor 322 may transmit, via transceiver 326, an LP-WUS to communication apparatus 310 in an event that the LP-WUS monitoring is activated.

In some implementations, the at least one pre-configured condition may comprise that the LP-WUS is a periodic reference signal for LR measurements.

In some implementations, the at least one pre-configured condition may comprise that an RRM measurement for an MR of communication apparatus 310 is relaxed.

In some implementations, the at least one pre-configured condition may comprise that a result of LP-WUS based measurement on an LP-WUR of communication apparatus 310 is below a threshold.

In some implementations, the at least one pre-configured condition may comprise a channel condition.

In some implementations, the channel condition may comprise that a coverage of the LP-WUS is sufficient or is insufficient.

### Illustrative Processes

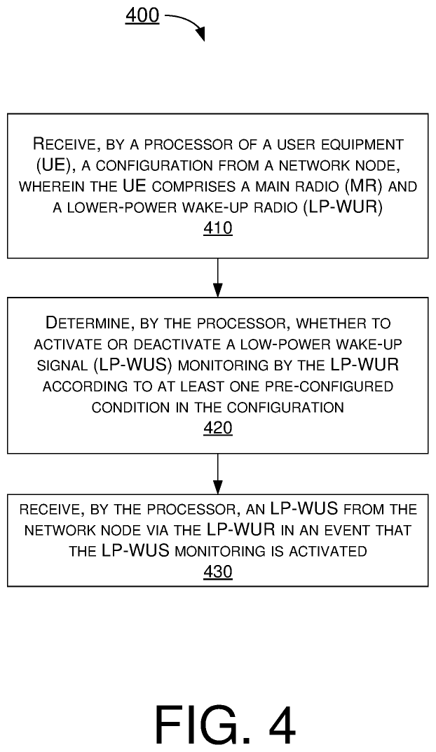

FIG. 4 illustrates an example process 400 in accordance with an implementation of the present disclosure. Process 400 may be an example implementation of above scenarios/schemes, whether partially or completely, with respect to the LP-WUS monitoring with the present disclosure. Process 400 may represent an aspect of implementation of features of communication apparatus 310. Process 400 may include one or more operations, actions, or functions as illustrated by one or more of blocks 410, 420 and 430. Although illustrated as discrete blocks, various blocks of process 400 may be divided into additional blocks, combined into fewer blocks, or eliminated, depending on the desired implementation. Moreover, the blocks of process 400 may be executed in the order shown in FIG. 4 or, alternatively, in a different order. Process 400 may be implemented by communication apparatus 310 or any suitable UE or machine type devices. Solely for illustrative purposes and without limitation, process 400 is described below in the context of communication apparatus 310. Process 400 may begin at block 410.

At 410, process 400 may involve processor 312 of communication apparatus 310 receiving a configuration from a network node, wherein communication apparatus 310 may comprises an MR and an LP-WUR. Process 400 may proceed from 410 to 420.

At 420, process 400 may involve processor 312 determining whether to activate or deactivate an LP-WUS monitoring by the LP-WUR according to at least one pre-configured condition in the configuration. Process 400 may proceed from 420 to 430.

At 430, process 400 may involve processor 312 receiving an LP-WUS from the network node via the LP-WUR in an event that the LP-WUS monitoring is activated.

In some implementations, process 400 may involve processor 312 offloading an RRM measurement from the MR to the LP-WUR in an event that the LP-WUS monitoring is activated. The at least one pre-configured condition may comprise that the LP-WUS is a periodic reference signal used for an LR measurement.

In some implementations, process 400 may involve processor 312 deactivating the LP-WUS monitoring on the LP-WUR in an event that the RRM measurement in the MR is relaxed, and performing a measurement with a relaxed periodicity via the MR

In some implementations, process 400 may involve processor 312 deactivating the LP-WUS monitoring on the LP-WUR in an event that a result of LP-WUS based measurement on the LP-WUR is below a threshold, and performing a measurement via the MR.

In some implementations, process 400 may involve processor 312 determining whether to activate or deactivate the LP-WUS monitoring by the LP-WUR according to a channel condition. The channel condition may comprise that a coverage of the LP-WUS is sufficient or is insufficient.

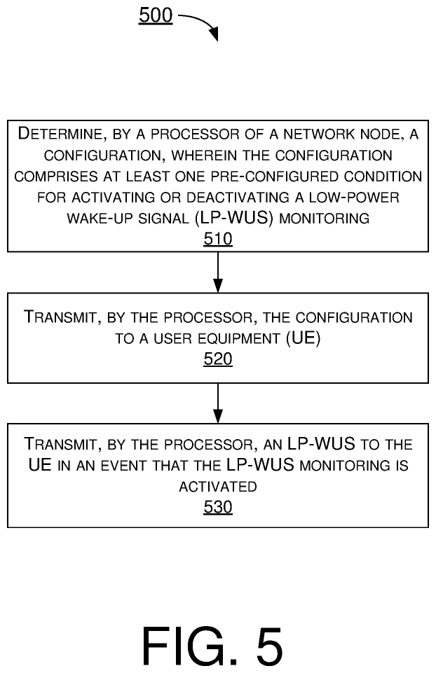

FIG. 5 illustrates an example process 500 in accordance with an implementation of the present disclosure. Process 500 may be an example implementation of above scenarios/schemes, whether partially or completely, with respect to the LP-WUS monitoring with the present disclosure. Process 500 may represent an aspect of implementation of features of network apparatus 320. Process 500 may include one or more operations, actions, or functions as illustrated by one or more of blocks 510, 520 and 530. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by network apparatus 320 or any base stations or network nodes. Solely for illustrative purposes and without limitation, process 500 is described below in the context of network apparatus 320. Process 500 may begin at block 510.

At 510, process 500 may involve processor 322 of network apparatus 320 determining a configuration, wherein the configuration comprises at least one pre-configured condition for activating or deactivating an LP-WUS monitoring. Process 500 may proceed from 510 to 520.

At 520, process 500 may involve processor 322 transmitting, via transceiver 326, the configuration to communication apparatus 310. Process 500 may proceed from 520 to 530.

At 530, process 500 may involve processor 322 transmitting, via transceiver 326, an LP-WUS to communication apparatus 310 in an event that the LP-WUS monitoring is activated.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of a user equipment (UE), a configuration from a network node, wherein the UE comprises a main radio (MR) and a lower-power wake-up radio (LP-WUR);
determining, by the processor, whether to activate or deactivate a low-power wake-up signal (LP-WUS) monitoring by the LP-WUR according to at least one pre-configured condition in the configuration; and
receiving, by the processor, an LP-WUS from the network node via the LP-WUR in an event that the LP-WUS monitoring is activated.

2. The method of claim 1, further comprising:
offloading, by the processor, a radio resource management (RRM) measurement from the MR to the LP-WUR in an event that the LP-WUS monitoring is activated.

3. The method of claim 2, wherein the at least one pre-configured condition comprises that the LP-WUS is a periodic reference signal used for a low-power radio (LR) measurement.

4. The method of claim 1, further comprising:
deactivating, by the processor, the LP-WUS monitoring on the LP-WUR in an event that the RRM measurement in the MR is relaxed; and
performing, by the processor, a measurement with a relaxed periodicity via the MR.

5. The method of claim 1, further comprising:
deactivating, by the processor, the LP-WUS monitoring on the LP-WUR in an event that a result of LP-WUS based measurement on the LP-WUR is below a threshold; and
performing, by the processor, a measurement via the MR.

6. The method of claim 1, further comprising:
determining, by the processor, whether to activate or deactivate the LP-WUS monitoring by the LP-WUR according to a channel condition.

7. The method of claim 6, wherein the channel condition comprises that a coverage of the LP-WUS is sufficient or is insufficient.

8. An apparatus, comprising:
a transceiver which, during operation, wirelessly communicates with at least one network node and comprises a main radio (MR) and a lower-power wake-up radio (LP-WUR); and
a processor communicatively coupled to the transceiver such that, during operation, the processor performs operations comprising:
receiving, via the transceiver, a configuration from the network node;
determining whether to activate or deactivate a low-power wake-up signal (LP-WUS) monitoring by the LP-WUR according to at least one pre-configured condition in the configuration; and
receiving, via the transceiver, an LP-WUS from the network node via the LP-WUR in an event that the LP-WUS monitoring is activated.

9. The apparatus of claim 8, wherein the processor is further configured to perform operations comprising:
offloading a radio resource management (RRM) measurement from the MR to the LP-WUR in an event that the LP-WUS monitoring is activated.

10. The apparatus of claim 9, wherein the at least one pre-configured condition comprises that the LP-WUS is a periodic reference signal used for low-power radio (LR) measurements.

11. The apparatus of claim 8, wherein the processor is further configured to perform operations comprising:
deactivating the LP-WUS monitoring on the LP-WUR in an event that the RRM measurement in the MR is relaxed; and
performing a measurement with a relaxed periodicity via the MR.

12. The apparatus of claim 8, wherein the processor is further configured to perform operations comprising:
deactivating the LP-WUS monitoring on the LP-WUR in an event that a result of the LP-WUS based measurement on the LP-WUR is below a threshold; and
performing a measurement via the MR.

13. The apparatus of claim 8, wherein the processor is further configured to perform operations comprising:
determining whether to activate or deactivate the LP-WUS monitoring according to a channel condition.

14. The apparatus of claim 13, wherein the channel condition comprises that a coverage of the LP-WUS is sufficient or is insufficient.

15. A method, comprising:
determining, by a processor of a network node, a configuration, wherein the configuration comprises at least one pre-configured condition for activating or deactivating a low-power wake-up signal (LP-WUS) monitoring;
transmitting, by the processor, the configuration to a user equipment (UE); and
transmitting, by the processor, an LP-WUS to the UE in an event that the LP-WUS monitoring is activated.

16. The method of claim 15, wherein the at least one pre-configured condition comprises that the LP-WUS is a periodic reference signal for low-power radio (LR) measurements.

17. The method of claim 15, wherein the at least one pre-configured condition comprises that a radio resource management (RRM) measurement for a main radio (MR) of the UE is relaxed.

18. The method of claim 15, wherein the at least one pre-configured condition comprises that a result of LP-WUS based measurement on a lower-power wake-up radio (LP-WUR) of the UE is below a threshold.

19. The method of claim 15, wherein the at least one pre-configured condition comprises a channel condition.

20. The method of claim 19, wherein the channel condition comprises that a coverage of the LP-WUS is sufficient or is insufficient.
